(19) United States
(12) Patent Application Publication
(10) Pub. No.: US 2008/0062352 A1
(43) Pub. Date: Mar. 13, 2008

(54) Light guide plate having light emitting unit receptacles and backlight module and liquid crystal display using the same

(75) Inventors: Hong Han, Shenzhen (CN); Chih-Hung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/899,915

(22) Filed: Sep. 7, 2007

(30) Foreign Application Priority Data
Sep. 8, 2006 (TW) 95133264

(51) Int. Cl. G02F 1/13357; F21V 8/00

(52) U.S. Cl. 349/65; 362/621

(57) ABSTRACT

An exemplary backlight module (23) used in a liquid crystal display (2) includes light emitting units (29), a light guide plate (26), and a frame (25) for receiving the light guide plate. The light guide plate includes a light incident surface (261) and protrusions (267) extending from the light incident surface. The protrusions together with corresponding portions of the light incident surface cooperatively define receptacles (260). Each of the receptacles has one of the light emitting units fittingly received therein.

### FIELD OF THE INVENTION

The present invention relates to light guide plates such as those used in liquid crystal displays (LCDs); and more particularly to a light guide plate having light emitting unit receptacles, a backlight module using the light guide plate, as well as a liquid crystal display using the backlight module.

### GENERAL BACKGROUND

The liquid crystal of an LCD does not itself emit light. Rather, the liquid crystal needs to be illuminated by a light source such as ambient light or an accompanying backlight. Thus a typical LCD has a backlight module installed therewith. The backlight module provides a uniform flat light source to enable the LCD to display images.

FIG. 7 is a schematic, top view of a conventional LCD prior to it being assembled. The LCD 1 includes a printed circuit board (PCB) 11, a liquid crystal panel 12 mechanically and electrically connected with one end of the PCB 11, two light emitting diodes (LEDs) 14 cooperatively serving as a light source, an LGP 15, and a frame 13 for receiving the PCB 11, the LEDs 14, and the LGP 15.

The PCB 11 includes a main area 110, and a subarea 112 extending from one end of the main area 110. The LEDs 14 are arranged on the subarea 112 of the PCB 11. The LGP 15 includes a light incident surface 151 adjacent to the LEDs 14, a top light emission surface 152 perpendicularly connecting with the light incident surface 151, and a bottom surface (not labeled) perpendicularly connecting with the light incident surface 151. The frame 13 includes a side wall 130 generally adjacent to the light incident surface 151 of the LGP 15. Two openings 131 are defined at an inner surface (not labeled) of the side wall 130. The openings 131 generally face toward the light incident surface 151, and are for receiving the LEDs 14.

The LCD 1 is assembled by the following steps. Firstly, the LGP 15 is received in the frame 13, with the light incident surface 151 located generally adjacent to the side wall 130. The light emission surface 152 of the LGP 15 is oriented face up. Secondly, the subarea 112 of the PCB 11 is disposed on the side wall 130 of the frame 13. Thus, the LEDs 14 disposed on the subarea 112 are received in the openings 131 and are located adjacent to the light incident surface 151 of the LGP 15. The main area 110 of the PCB 11 is folded down and around to a location adjacent to the bottom surface of the LGP 15. Then the liquid crystal panel 12 is folded up and around to a location adjacent to the light emission surface 152 of the LGP 15. Thereby, the subarea 112 of the PCB 11 is sandwiched generally between the side wall 130 of the frame 13 and the liquid crystal panel 12.

The LEDs 14 are thus positioned in the openings 131, and located adjacent to the light incident surface 151 of the LGP 15. However, due to imprecision in the manufacture of the LCD 1, the size of the frame 13 may not precisely match the size of the LGP 15. In such case, gaps may exist between the frame 13 and the LGP 15. Then when the LCD 1 is transported or utilized by an end user, the LCD 1 may be subjected to vibration or shock. When this happens, the light incident surface 151 of the LGP 15 is liable to deviate from the side wall 130 of the frame 13. As a result, the distance from the LEDs 14 to the light incident surface 151 is increased. Then in use, some of the light beams emitted from the LEDs 14 may not enter the incident surface 151 of the LGP 15. Thus, the emitting luminance of the LGP 15 is diminished.

FIG. 8 is a graph showing a relationship between the relative emitting luminance of the LGP 15 and the distance from each of the LEDs 14 to the light incident surface 151. The X abscissa represents the distance from each of the LEDs 14 to the light incident surface 151 in millimeters (mm). The Y ordinate represents the relative emitting luminance of the LGP 15 as a function of X. It can be seen that the greater the value of X, the lower the value of Y. That is, the greater the distance from the LEDs 14 to the light incident surface 151, the lower the value of the relative emitting luminance of the LGP 15.

What is needed, therefore, is a light guide plate and a backlight module and liquid crystal display employing such a light guide plate that can overcome the above-described deficiencies.

### SUMMARY

A backlight module includes a plurality of light emitting units, a light guide plate, and a frame for receiving the light guide plate. The light guide plate includes a light incident surface and a plurality of protrusions extending from the light incident surface. The protrusions together with corresponding portions of the light incident surface cooperatively define a plurality of receptacles. Each of the receptacles has one of the light emitting units fittingly received therein.

A liquid crystal display includes a liquid crystal panel, and a backlight module opposite to the liquid crystal panel. The backlight module includes a plurality of light emitting units and a light guide plate. The light guide plate includes a light incident surface and a plurality of protrusions extending from the light incident surface. The protrusions together with corresponding portions of the light incident surface cooperatively define a plurality of receptacles, and each of the receptacles has one of the light emitting units fittingly received therein.

A light guide plate includes a light incident surface and a plurality of protrusions extending from the light incident surface. The protrusions together with corresponding portions of the light incident surface cooperatively define a plurality of receptacles, and each of the receptacles has one of the light emitting units fittingly received therein.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of an LCD according to a first embodiment of the present invention, the LCD including a backlight module.

FIG. 2 is an enlarged view of a circled portion, labeled II, of FIG. 1.

FIG. 3 is an assembled view of the backlight module of FIG. 1.

FIG. 4 is an assembled view of the LCD of FIG. 1.

FIG. 5 is an isometric view of a part of an LGP of a backlight module according to a second embodiment of the present invention.

FIG. 6 is an isometric view of a part of an LGP of a backlight module according to a third embodiment of the present invention.

FIG. 7 is a schematic, top view of a conventional LCD prior to it being assembled, the LCD including an LGP and a plurality of LEDs.

FIG. 8 is a graph relating to performance of the LCD of FIG. 7 once it has been assembled and is in use, the graph showing a relationship between relative emitting luminance of the LGP and a distance from each of the LEDs to a light incident surface of the LGP.

### DETAILED DESCRIPTION OF PREFERRED EMBODIMENTS

Reference will now be made to the drawings to describe the preferred embodiments in detail.

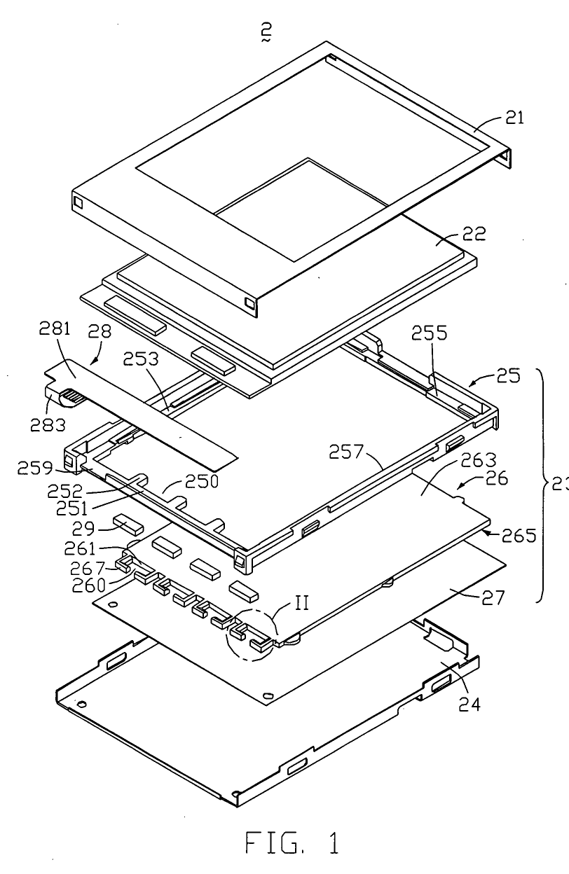

FIG. 1 is an exploded, isometric view of an LCD according to a first embodiment of the present invention. The LCD 2 mainly includes a top cover 21, a liquid crystal panel 22 for displaying images, a backlight module 23 for providing light beams to the liquid crystal panel 22, and a bottom cover 24. The top cover 21 and the bottom cover 24 are coupled together to cooperatively accommodate the liquid crystal panel 22 and the backlight module 23 therein. The top cover 21 and the bottom cover 24 may be made of iron or another suitable metal.

The backlight module 23 includes an LGP 26, a reflector 27, a flexible printed circuit board (FPCB) 28, a plurality of light emitting units 29, and a frame 25 for receiving the LGP 26, the reflector 27, the FPCB 28, and the light emitting units 29. In the illustrated embodiment, there are four light emitting units 29. The light emitting units 29 can for example be light emitting diodes (LEDs).

The FPCB 28 includes an attaching area 281, and a connection strip 283 extending from the attaching area 281. The LEDs 29 are disposed on an underside of the attaching area 281 of the FPCB 28.

The frame 25 includes a first side wall 251, a second side wall 253, a third side wall 255, and a fourth side wall 257. The first, second, third, and fourth side walls 251, 253, 255, 257 cooperatively form a four-sided closed space (not labeled) therebetween, for receiving the LGP 26, the reflector 27, and the LEDs 29. The side walls 251, 253, 255, 257 include a plurality of locking lugs (not labeled) respectively disposed at outer surfaces thereof.

The first side wall 251 includes a gap 259. The connection strip 283 extends out of the frame 25 through the gap 259. The first side wall 251 further includes a plurality of protrusions 252 that are parallel with each other. The protrusions 252 extend from an inner surface (not labeled) of the first side wall 251, and thereby define a plurality of notches 250 therebetween.

The LGP 26 includes a light incident surface 261 adjacent to the first side wall 251 of the frame 25, a top light emission surface 263 perpendicularly connecting with the light incident surface 261, a bottom surface 265 perpendicularly connecting with the light incident surface 261, and a plurality of L-shaped protrusions 267 extending from the light incident surface 261. In the illustrated embodiment, there are eight L-shaped protrusions 267, arranged as four pairs. In each pair, the two adjacent L-shaped protrusions 267 are symmetrically opposite each other. The two L-shaped protrusions 267 together with a corresponding portion of the light incident surface 261 cooperatively define a receptacle 260, the receptacle 260 having an open side where free ends of the L-shaped protrusions 267 oppose each other. The receptacle 260 is for receiving a corresponding LED 29. The LGP 26 can for example be made of polymethyl methacrylate (PMMA) or polycarbonate (PC). Thus the L-shaped protrusions 267 are elastically deformable to a certain degree.

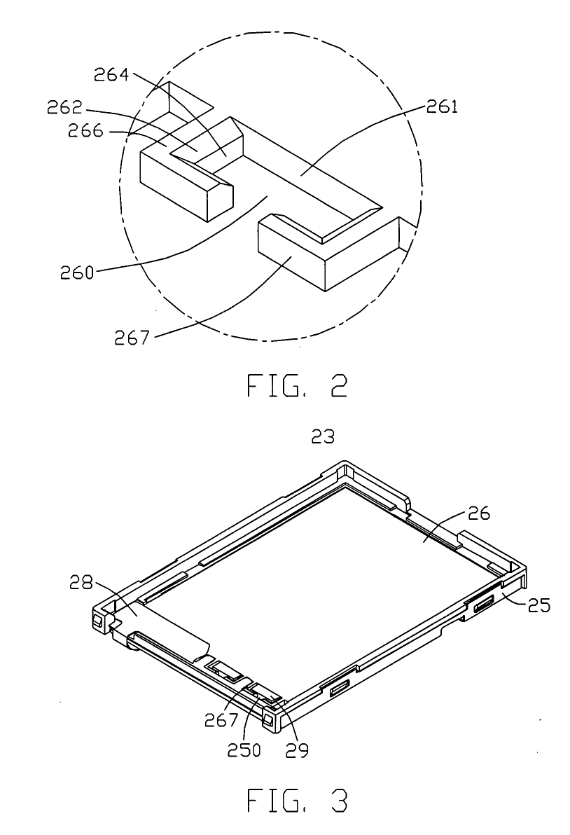

Also referring to FIG. 2, the L-shaped protrusions 267 are integrally formed with a main body of the LGP 26. The L-shaped protrusions 267 have a same thickness as the main body of the LGP 26, and are substantially coplanar with the main body of the LGP 26. A first arm of each L-shaped protrusion 267 perpendicularly extends from the light incident surface 261, and a second arm of the L-shaped protrusion 267 extends from the first arm and is parallel to the light incident surface 261. That is, the two arms of the L-shaped protrusion 267 form a right angle. A chamfer 262 is formed on both arms of the L-shaped protrusion 267, between an inner surface 264 and a top surface 266 of the L-shaped protrusion 267.

The top cover 21 includes two side walls (not labeled) opposite to each other. The side walls of the top cover 21 include a plurality of locking holes (not labeled), corresponding to the locking lugs of the first and third side walls 251, 255 of the frame 25. The bottom cover 24 includes three side walls (not labeled). Two opposite of the side walls of the bottom cover 24 include a plurality of locking holes (not labeled), corresponding to the locking lugs of the second and fourth side walls 253, 257 of the frame 25.

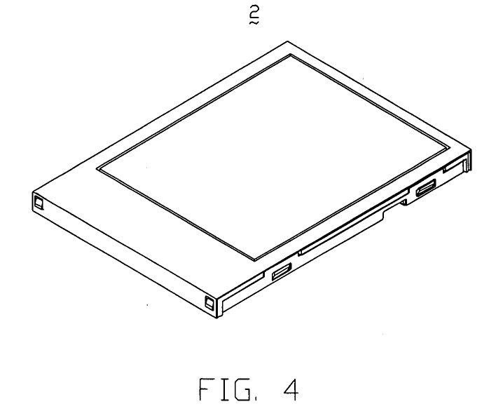

Also referring to FIG. 3, this is an assembled view of the backlight module 23. The backlight module 23 is assembled by the following steps. Firstly, the reflector 27 is disposed in the frame 25. Secondly, the LGP 26 is disposed on the reflector 27, with the bottom surface 265 abutting the reflector 27. Each pair of L-shaped protrusions 267 is located in a corresponding notch 250 of the first side wall 251 of the frame 25. Thirdly, the FPCB 28 is placed on the first side wall 251. In this process, the LEDs 29 are fittingly received in the receptacles 260 of the LGP 26. The connection strip 283 extends out of the frame 25 through the gap 259 of the first side wall 251. A free end portion of the connection strip 283 is folded down and around to an underside of the reflector 27.

Also referring to FIG. 4, an assembled view of the LCD 2 is shown. After the backlight module 23 is assembled, the LCD 2 can be further assembled by the following steps. Firstly, the liquid crystal panel 22 is placed above the LGP 26 so that the liquid crystal panel 22 is adjacent to the light incident surface 261 of the LGP 26. Thereby, the FPCB 28 is sandwiched between the liquid crystal panel 22 and the first side wall 251. Subsequently, the locking lugs of the second and fourth side walls 253, 257 are engaged in the locking holes of the bottom cover 24, so as to fix the bottom cover 24 to the frame 25. Finally, the locking lugs of the first and third side walls 251, 255 are engaged in the locking holes of the top cover 21, so as to fix the top cover 21 to the frame 25.

With the L-shaped protrusions 267, the LGP 26 forms a plurality of receptacles 260 at the light incident surface 261. The L-shaped protrusions 267 are integrated with the main body of the LGP 26, and are elastically deformable. Thereby, the LEDs 29 can be firmly engaged in the receptacles 260. Accordingly, even if there are gaps between the frame 25 and the LGP 26, a constant distance between each LED 29 and the corresponding portion of the light incident surface 261 is maintained. Preferably, each LED 29 abuts against the corresponding portion of the light incident surface 261. As a result, most or even all of the light beams emitted from the LEDs 29 enter the LGP 26 via the light incident surface 261. Thereby, the emitting luminance of the LGP 26 is increased.

Furthermore, at each L-shaped protrusion 267, the chamfer 262 is provided between the top surface 266 and the inner surface 264. Therefore, at each pair of L-shaped protrusions 267, the corresponding LED 29 can be easily inserted into and engaged in the receptacle 260 of the LGP 26. This makes assembly of the LCD 2 convenient.

FIG. 5 is an isometric view of a part of an LGP 36 of a backlight module according to a second embodiment of the present invention. The LGP 36 has a structure similar to that of the LGP 26. However, a first arm of each of L-shaped protrusions 367 perpendicularly extends from a light incident surface 361 of the LGP 36, and a second arm of the L-shaped protrusion 367 extends oblique from the first arm slightly toward the light incident surface 361. That is, the two arms of the L-shaped protrusion 367 form an acute angle. Each pair of L-shaped protrusions 367 together with a corresponding portion of the light incident surface 361 of the LGP 36 define a receptacle 360, the receptacle 360 having an open side where free ends of the L-shaped protrusions 367 oppose each other. The receptacle 360 is for receiving a corresponding LED (not shown).

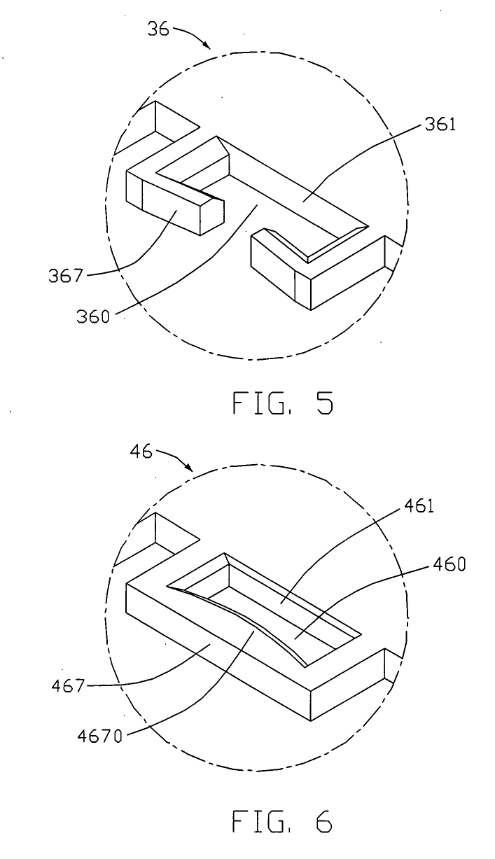

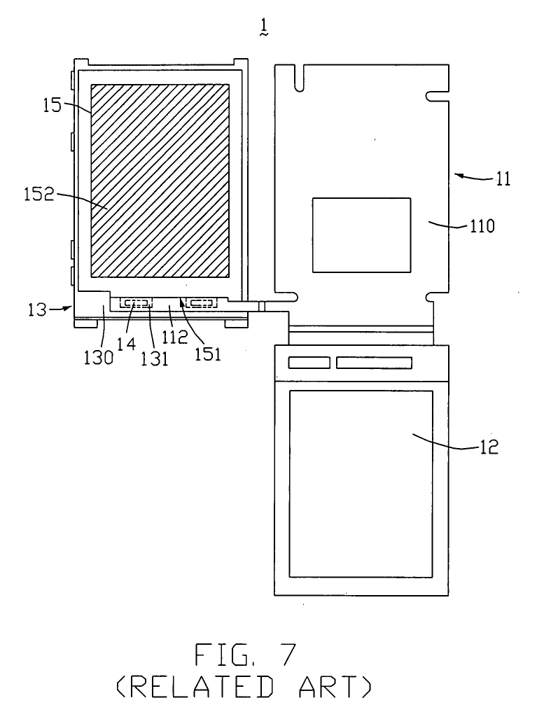

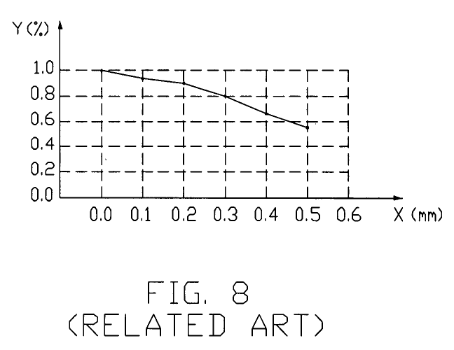

FIG. 6 is an isometric view of a part of an LGP 46 of a backlight module according to a third embodiment of the present invention. The LGP 46 has a structure similar to that of the LGP 26. However, a light incident surface 461 of the LGP 46 has a plurality of generally U-shaped protrusions 467 extending therefrom. Each of the U-shaped protrusions 467 includes a main body (not labeled) parallel with the light incident surface 461, and two arms perpendicularly extending from the light incident surface 461. The main body of each U-shaped protrusion 467 includes an arc-shaped bulge 4670 at an inner surface thereof. The arc-shaped bulge 4670 protrudes slightly from a main portion of the main body toward the light incident surface 461. Each of the U-shaped protrusions 467 together with a corresponding portion of the light incident surface 461 defines a receptacle 460 for receiving a corresponding LED (not shown).

Various modifications and alterations are possible within the ambit of the invention herein. For example, in the first embodiment, the chamfer 262 formed between the inner surface 264 and the top surface 266 of each L-shaped protrusion 267 can instead be a curved or rounded fillet.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a plurality of light emitting units;
a light guide plate comprising a light incident surface and a plurality of protrusions extending from the light incident surface, wherein the protrusions together with corresponding portions of the light incident surface cooperatively define a plurality of receptacles, and each of the receptacles has one of the light emitting units fittingly received therein; and
a frame receiving the light guide plate.

2. The backlight module as claimed in claim 1, wherein the protrusions are integrally formed with a main body of the light guide plate.

3. The backlight module as claimed in claim 1, wherein the protrusions have a same thickness as the light guide plate.

4. The backlight module as claimed in claim 1, wherein the protrusions are generally L-shaped protrusions.

5. The backlight module as claimed in claim 4, wherein the L-shaped protrusions are arranged in pairs, and in each pair, the two adjacent L-shaped protrusions are symmetrically opposite each other.

6. The backlight module as claimed in claim 4, wherein each L-shaped protrusion comprises a first arm and a second arm, the first arm perpendicularly extends from the light incident surface, and the second arm extends from the first arm and is parallel to the light incident surface.

7. The backlight module as claimed in claim 4, wherein each L-shaped protrusion comprises a first arm and a second arm, the first arm perpendicularly extends from the light incident surface, and the second arm extends obliquely from the first arm slightly toward the light incident surface.

8. The backlight module as claimed in claim 4, wherein each L-shaped protrusion further comprises an inner surface and a top surface, and a chamfer between the inner surface and the top surface.

9. The backlight module as claimed in claim 4, wherein each L-shaped protrusion further comprises an inner surface and a top surface, and a curved fillet between the inner surface and the top surface.

10. The backlight module as claimed in claim 4, wherein each L-shaped protrusion further comprises an inner surface and a top surface, and a rounded fillet between the inner surface and the top surface.

11. The backlight module as claimed in claim 1, wherein the protrusions are elastically deformable.

12. The backlight module as claimed in claim 1, wherein the protrusions are U-shaped protrusions.

13. The backlight module as claimed in claim 12, wherein each U-shaped protrusion comprises a main body and two arms.

14. The backlight module as claimed in claim 13, wherein the arms perpendicularly extend from the light incident surface, and the main body is between the arms and parallel with the light incident surface.

15. The backlight module as claimed in claim 14, wherein the main body comprises an inner surface, and a bulge is formed at the inner surface.

16. The backlight module as claimed in claim 15, wherein the bulge protrudes towards the light incident surface.

17. A liquid crystal display, comprising:
a liquid crystal panel; and
a backlight module opposite to the liquid crystal panel, the backlight module comprising:
a plurality of light emitting units; and
a light guide plate comprising a light incident surface and a plurality of protrusions extending from the light incident surface;
wherein the protrusions together with corresponding portions of the light incident surface cooperatively define a plurality of receptacles, and each of the receptacles has one of the light emitting units fittingly received therein.

18. The liquid crystal display as claimed in claim 17, wherein the backlight module further comprises a frame, and the frame receives the light guide plate.

19. A light guide plate, comprising:
a light incident surface; and
a plurality of protrusions extending from the light incident surface;
wherein the protrusions together with corresponding portions of the light incident surface cooperatively define a plurality of receptacles, and each of the receptacles is configured for having a light emitting unit fittingly received therein.
